(19) United States
(12) Patent Application Publication
(10) Pub. No.: US 2015/0043150 A1
(43) Pub. Date: Feb. 12, 2015

(54) ELECTRONIC DEVICE WITH DATA STORAGE DEVICE HOLDER

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: YU-YAN LIU, Wuhan (CN); ZHI-PING WU, Wuhan (CN); CHAO LIU, Wuhan (CN); YAN LI, Wuhan (CN)

(21) Appl. No.: 14/453,995

(22) Filed: Aug. 7, 2014

(30) Foreign Application Priority Data
Aug. 9, 2013 (CN) 201310346334X

(51) Int. Cl. G06F 1/18

(52) U.S. Cl. CPC G06F 1/187; G06F 1/185
USPC 361/679.33; 361/679.32

(57) ABSTRACT

An electronic device including a holder for holding a bracket in a circuit board is disclosed. The electronic device includes a chassis. An electronic component is secured to the chassis. The bracket includes a bottom wall. The holder is located between the bottom wall and the circuit board. The bracket is located above the electronic component. The holder includes a mounting portion secured to the bottom wall and a holding portion abuts the circuit board, and a height of the holding portion is substantially equal to a distance between the bottom wall and the circuit board.

### FIELD

Embodiments of the present disclosure relate to electronic devices, and particularly to an electronic device with a data storage device holder.

### BACKGROUND

A number of data storage devices are used for storing data in electronic devices, such as computers and servers. The data storage devices are generally mounted in a bracket, and the bracket is mounted in a computer enclosure by screws. A number of expansion cards are generally secured under the bracket.

### BRIEF DESCRIPTION OF THE DRAWINGS

Many aspects of the embodiments herein can be better understood with reference to the following drawings. The components in the drawings are not necessarily drawn to scale, the emphasis instead being placed upon clearly illustrating the principles of the embodiments. Like reference numerals designate corresponding parts throughout the several views of the drawings.

FIG. 1 is an exploded, isometric view of one embodiment of an electronic device.

FIG. 2 is an isometric view of a holder of the electronic device of FIG. 1.

FIG. 3 is an assembled, isometric view of the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

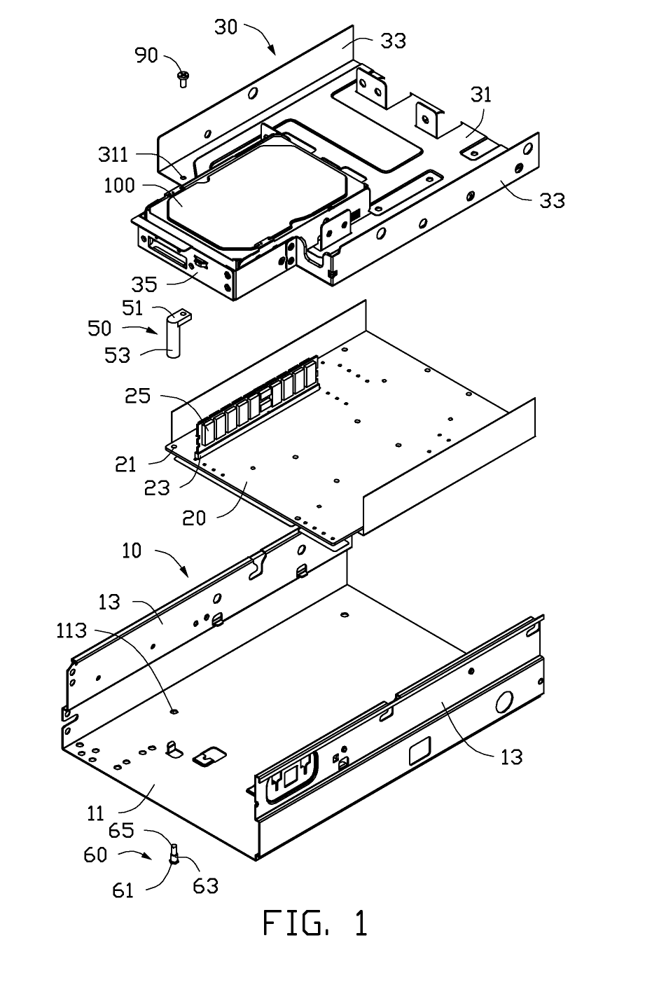

FIG. 1 illustrates one embodiment of an electronic device. The electronic device includes a chassis 10, a circuit board 20, a bracket 30, a holder 50, and a limiting member 60.

The chassis 10 includes a bottom plate 11 and two side plates 13 substantially perpendicularly extending from opposite edges of the bottom plate 11. In one embodiment, the bottom plate 11 is substantially perpendicular to each side plate 13. The bottom plate 11 defines a mounting hole 113.

The circuit board 20 defines a limiting hole 21. A plurality of card connectors 23 (only one of the plurality of card connectors 23 is shown) is secured to the circuit board 20. An electronic component 25 is inserted in the card connector 23. In one embodiment, the electronic component 25 is an expansion card.

The bracket 30 includes a bottom wall 31 and two sidewalls 33 substantially perpendicularly extending from opposite edges of the bottom wall 31. In one embodiment, the bottom wall 31 is substantially perpendicular to each sidewall 33. A plurality of cages 35 (only one of the plurality of cages 35 is shown) is secured to the bottom wall 31. A data storage device 100 is secured to the cage 35. The bottom wall 31 further defines a locking hole 311. In one embodiment, the data storage device 100 is a hard disk drive.

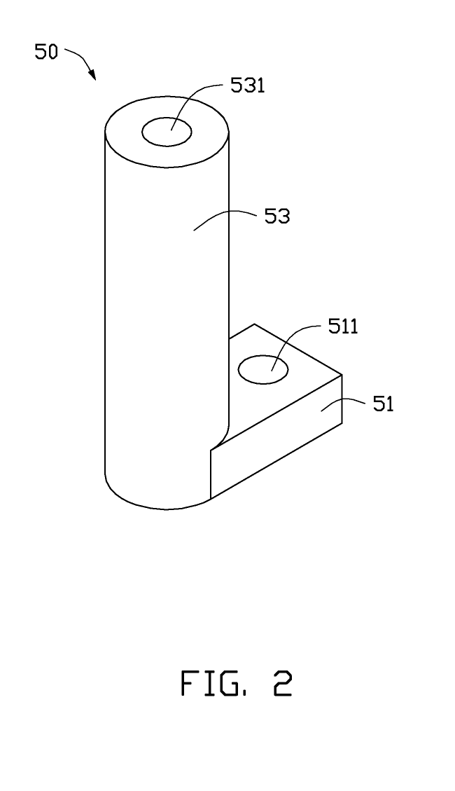

FIG. 2 illustrates that the holder 50 includes a mounting portion 51 and a holding portion 53. The mounting portion 51 defines a through hole 511 corresponding to the locking hole 311. A first end of the holding portion 53 extends from the mounting portion 51. A second end of the holding portion 53 defines a receiving hole 531. In one embodiment, the mounting portion 51 is a flake, the holding portion 53 is columnar, and the mounting portion 51 is substantially perpendicular to the holding portion 53.

The limiting member 60 includes an installation portion 61, a blocking portion 63, and a limiting portion 65. The blocking portion 63 is connected between the installation portion 61 and the limiting portion 65. In one embodiment, a cross section of the limiting portion 65 is circular. A diameter of the cross section of the limiting portion 65 is substantially equal to a diameter of each of the limiting hole 21 and the receiving hole 531.

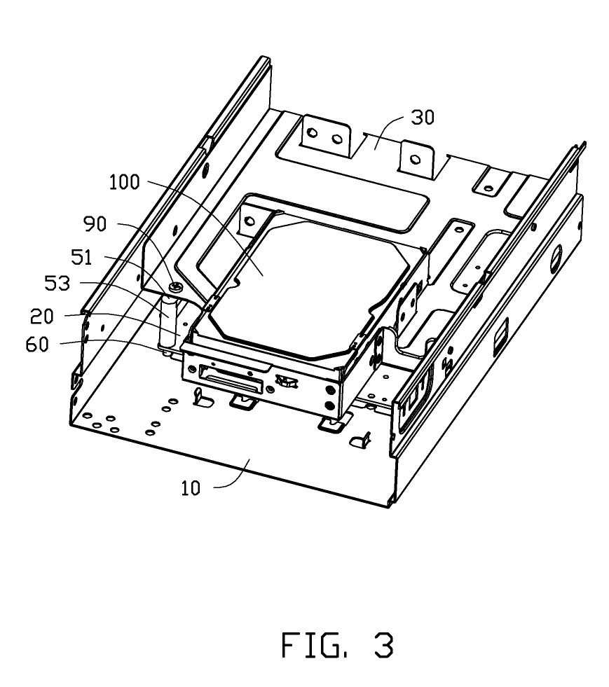

FIG. 3 illustrates that when the electronic device is in an assembled configuration, the blocking portion 63 and the limiting portion 65 extend out of the mounting hole 113. The installation portion 61 is secured to edges of the mounting hole 113. The circuit board 20 is moved to the bottom plate 11 with the limiting hole 21 being aligned with the limiting portion 65. The circuit board 20 is moved towards the bottom plate 11 until blocked by the blocking portion 63. In this position, the limiting portion 65 extends out of the limiting hole 21, and the blocking portion 63 is located between the bottom plate 11 and the circuit board 20 to hold the circuit board 20 and prevent the circuit board 20 from touching the bottom plate 11. A height of the blocking portion 63 is substantially equal to a distance between the bottom plate 11 and the circuit board 20. The holder 50 is placed under the bottom wall 31. A locking member 90, such as a screw, is inserted through the locking hole 311 and the through hole 511, securing the mounting portion 51 to the bottom wall 31. The bracket 30 is moved above the circuit board 20 with the receiving hole 531 aligned to the limiting portion 65. The bracket 30 is moved towards the circuit board 20 until the holding portion 53 abuts the circuit board 20. In this position, the limiting portion 65 is received in the receiving hole 531 and is positioned on a side of the electronic component 25. The mounting portion 51 is located between the bottom wall 31 and a top edge of the electronic component 25. In one embodiment, a height of the holding portion 53 is substantially equal to a distance between the bottom wall 31 and the circuit board 20. A distance between the two sidewalls 33 is substantially equal to a distance between the two side plates 13.

The holder 50 holds the bracket 30 on the circuit board 20, preventing the bracket 30 from being shaken in a direction substantially perpendicular to the bottom plate 11.

It is to be understood that even though numerous characteristics and advantages have been set forth in the foregoing description, together with details of the structures and functions of the embodiments, the disclosure is illustrative only and changes may be made in detail, including in the matters of shape, size, and the arrangement of parts within the principles of the disclosure. The embodiments discussed herein do not limit the following claims.

What is claimed is:

1. An electronic device comprising:
a chassis;
a circuit board mounted in the chassis;
a bracket secured to the chassis and comprising a bottom wall; and
a holder located between the bottom wall and the circuit board;
wherein the holder comprises a mounting portion secured to the bottom wall and a holding portion abutting the circuit board, and a height of the holding portion is substantially equal to a distance between the bottom wall and the circuit board.

2. The electronic device of claim 1, further comprising a limiting member securing the circuit board to the chassis, wherein the limiting member comprises a limiting portion extending out of the circuit board, the holder defines a receiving hole, and the limiting portion is received in the receiving hole, preventing the holding portion from moving relative to the circuit board.

3. The electronic device of claim 2, wherein the chassis comprises a bottom plate, the limiting member further comprises a blocking portion and an installation portion, the installation portion is secured to the bottom plate, and the blocking portion is located between the bottom plate and the circuit board, preventing the circuit board from touching the bottom plate.

4. The electronic device of claim 3, wherein a height of the blocking plate is substantially equal to a distance between the bottom plate and the circuit board.

5. The electronic device of claim 3, wherein the blocking portion is located between the installation portion and the limiting portion, the circuit board defines a limiting hole, and the limiting portion extends out of the limiting hole.

6. The electronic device of claim 5, wherein a cross section of the limiting portion is circular, a diameter of the cross section of the limiting portion is substantially equal to a diameter of each of the limiting hole and the receiving hole.

7. The electronic device of claim 1, wherein the holding portion is substantially perpendicular to the mounting portion.

8. The electronic device of claim 1, wherein an electronic component is mounted on the circuit board, the bracket is located above the electronic component, the mounting portion is located between the bottom wall and a top edge of the electronic component.

9. The electronic device of claim 1, wherein the mounting portion is a flake, and the holding portion is columnar.

10. The electronic device of claim 1, wherein the bracket further comprises two sidewalls extending from opposite edges of the bottom wall and a cage secured to the bottom wall, the chassis further comprises two side plates, the two sidewalls are secured between the two side plates, and the cage is configured to secure a data storage device.

11. An electronic device comprising:
a chassis;
a circuit board, with an electronic component secured thereon, mounted in the chassis;
a bracket secured to the chassis and comprising a bottom wall; and
a holder located between the bottom wall and the circuit board;
wherein the bracket is located above the electronic component, the holder comprises a mounting portion secured to the bottom wall and a holding portion abutting the circuit board, and a height of the holding portion is substantially equal to a distance between the bottom wall and the circuit board.

12. The electronic device of claim 11, further comprising a limiting member securing the circuit board to the chassis, wherein the limiting member comprises a limiting portion extending out of the circuit board, the holder defines a receiving hole, and the limiting portion is received in the receiving hole, preventing the holding portion from moving relative to the circuit board.

13. The electronic device of claim 12, wherein the chassis comprises a bottom plate, the limiting member further comprises a blocking portion and an installation portion, the installation portion is secured to the bottom plate, and the blocking portion is located between the bottom plate and the circuit board, preventing the circuit board from touching the bottom plate.

14. The electronic device of claim 13, wherein a height of the blocking plate is substantially equal to a distance between the bottom plate and the circuit board.

15. The electronic device of claim 13, wherein the blocking portion is located between the installation portion and the limiting portion, the circuit board defines a limiting hole, and the limiting portion extends out of the limiting hole.

16. The electronic device of claim 15, wherein a cross section of the limiting portion is circular, a diameter of the cross section of the limiting portion is substantially equal to a diameter of each of the limiting hole and the receiving hole.

17. The electronic device of claim 11, wherein the holding portion is substantially perpendicular to the mounting portion.

18. The electronic device of claim 11, wherein the mounting portion is located between the bottom wall and a top edge of the electronic component.

19. The electronic device of claim 11, wherein the mounting portion is a flake, and the holding portion is columnar.

20. The electronic device of claim 11, wherein the bracket further comprises two sidewalls extending from opposite edges of the bottom wall and a cage secured to the bottom wall, the chassis further comprises two side plates, the two sidewalls are secured between the two side plates, and the cage is configured to secure a data storage device.
